(19) United States
(12) Patent Application Publication
(10) Pub. No.: US 2006/0165956 A1
(43) Pub. Date: Jul. 27, 2006

(54) Ceramic honeycomb structure body and manufacturing method thereof

(75) Inventor: Kazuya Souda, Kariya-shi (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 11/324,309

(22) Filed: Jan. 4, 2006

(30) Foreign Application Priority Data
Jan. 14, 2005 (JP) 2005-007978
Oct. 31, 2005 (JP) 2005-315884

(51) Int. Cl. B29C 47/12; B32B 3/12; B28B 11/16; B29C 47/00; C04B 33/32

(52) U.S. Cl. 428/116; 264/177.12; 264/145; 264/630

(57) ABSTRACT

A manufacturing method of a ceramic honeycomb structure body has extrusion molding with ceramic raw materials in a honeycomb structure, cutting to cut a molded one into plural mold bodies, each mold body having an outer peripheral skin part and plural cell walls. The manufacturing method performs a drying process of drying each mold body, a chamfering process of chamfer an edge of a corner of the mold body, and a burning process of burning the mold body in order to form the ceramic honeycomb structure body. The chamfered part has crystal particles of a cordierite 2MgO.2Al₂.O₃.5SiO₂.

### CROSS-REFERENCE TO RELATED APPLICATIONS

This application is related to and claims priority from Japanese Patent Applications No. 2005-7978 filed on Jan. 14, 2005 and No. 2005-315884 filed on Oct. 31, 2005, the contents of which are hereby incorporated by reference.

### BACKGROUND OF THE INVENTION

1. Field of the invention

The present invention relates to a ceramic honeycomb structure body and a manufacturing method thereof, which is used in a catalyst supporter and a filter in an exhaust gas purifying apparatus for vehicles.

2. Description of the Related Art

A ceramic honeycomb structure body is widely and commonly used as a catalyst supporter and various filters in an exhaust gas purifying apparatus of a vehicle. The ceramic honeycomb structure body has come to light as a filter for capturing particulate contaminants to be exhausted from a diesel engine of a vehicle.

FIG. 14 is a perspective diagram showing a conventional ceramic honeycomb structure body 9. The ceramic honeycomb structure body 9 is composed of an outer peripheral skin part 92 and a plurality of cell walls 93 formed in a honeycomb structure surrounded by the outer peripheral skin part 92. The ceramic honeycomb structure body 9 is contained in a steel case and mounted on an exhaust gas system in order to react or activate a catalyst captured in the body 9 by thermal energy of the exhaust gas and to purify the exhaust gas therein.

In a conventional manufacturing method of a ceramic honeycomb structure body, at first, extrusion molding and cutting are performed with ceramic raw materials so as to form a plurality of honeycomb mold bodies.

Next, drying and burning for the honeycomb mold body 90 are performed so as to form a ceramic honeycomb structure body 9.

However, during handling, transmitting, or carrying the ceramic mold bodies 90 in the manufacturing processes because stress is concentrated at the edge 94 of the end surface 912 of the honeycomb mold body 90, there is a possibility to generate cracks at the edge 94 of the end surface 912 of the honeycomb mold body 90. Further, it often occurs to contact the edges 94 of the end surface 912 in the honeycomb mold body 90 to the steel case when it is contained in the steel case. This introduces a difficulty of assembling the honeycomb mold body 90 during the manufacturing processes, and there is also possible to cause edge failure in the honeycomb mold body 90 and to generate cracks in the honeycomb mold body 90.

In order to avoid the conventional drawbacks described above, there has proposed a conventional method of chamfering an edge of an end surface of a ceramic honeycomb mold body by the Japanese patent laid open publication No. JP-2002-18290. This method can reduce occurrence of the edge failure in the ceramic honeycomb structure body and further improve assembling to contain the ceramic honeycomb structure body into a steel case.

In the conventional manufacturing method, chamfering to the ceramic mold body is performed after the burning of the honeycomb mold body. However, because a hardness of the ceramic honeycomb structure body after the burning is extremely high, it needs time to perform the chamfering for the ceramic honeycomb structure body, and so that it is difficult to reduce the processing time necessary for the chamfering.

Further, the manufacturing cost of the honeycomb structure body becomes increased because of the necessary to frequently replace a diamond grindstone with new one as a tool for the chamfering process.

Furthermore, there is a possibility to happen the edge failure at the corner section of the ceramic honeycomb structure body when the honeycomb mold body is handled, carried and transmitted after the cutting process of the mold body and before the burning process.

Still furthermore, because a speed of a temperature increase in the burning process is different in each part of the honeycomb mold body, a stress is often concentrated at the edge of the corner section in the honeycomb mold body. The presence of the edge of the corner section in the honeycomb mold body often causes cracks.

### SUMMARY OF THE INVENTION

The present invention has been made in consideration of those drawbacks of the prior art described above. An object of the present invention is to provide a ceramic honeycomb structure body and a manufacturing method thereof, which have a superior processability and extremely lessen the occurrence of the edge failure and the generation of cracks in the ceramic honeycomb structure body.

According to an aspect of the present invention, a manufacturing method of a ceramic honeycomb structure body has steps of an extrusion molding, a chamfering, and a burning. In the extrusion molding, the extrusion and molding is performed with ceramic raw materials so as to form a ceramic mold body in a honeycomb structure, and the cutting for the molded one is performed in order to form a plurality of honeycomb mold bodies. Each honeycomb mold body comprises an outer peripheral skin part and a plurality of cell walls in the honeycomb mold body. In the chamfering, an edge of an end surface of the honeycomb mold body is chamfered so as to form a chamfered part at the edge of the end surface in the honeycomb mold body. In the burning, the honeycomb mold body with the chamfered part of the end surface is burned so as to form a ceramic honeycomb structure body.

### BRIEF DESCRIPTION OF THE DRAWINGS

For a better understanding of the present invention and to show how the same may be carried out into effect, there will now be described by way of example only, specific embodiments and methods according to the present invention with reference to the according to the present invention.

FIG. 1 is a flow chart showing a manufacturing process of a ceramic honeycomb structure body according to a first embodiment of the present invention;

FIG. 2 is a timing diagram of the burning process in the manufacturing process of the first embodiment;

FIG. 3 is a perspective diagram of the ceramic honeycomb structure body according to the first embodiment of the present invention;

FIG. 4 is a side diagram of a chamfered part at an edge of an end surface in the ceramic honeycomb structure body according to the first embodiment;

FIG. 5 is a diagram showing a containing process of the ceramic honeycomb structure body into a steel case during the manufacturing process of the first embodiment;

FIG. 6 is a sectional diagram of an exhaust gas purifying apparatus equipped with the ceramic honeycomb structure body of the first embodiment;

FIG. 7 is a sectional diagram showing a chamfered part at the edge of the end surface in the ceramic honeycomb structure body according to a second embodiment of the present invention;

FIG. 8 is a sectional diagram showing a R surface formed at the edge of the end surface in the ceramic honeycomb structure body obtained in the first embodiment of the present invention;

FIG. 9 is a sectional diagram showing a C surface formed at the edge of the end surface in the ceramic honeycomb structure body obtained in the second embodiment of the present invention;

FIG. 10 is a diagram showing edge failure in the ceramic honeycomb structure body and taken along the line A-A of FIG. 11;

FIG. 11 is a perspective diagram showing edge failure at the edge of the end surface in the ceramic honeycomb structure body;

FIG. 12 is a scanning electron microscope (SEM) photograph showing a surface of the chamfered part at the edge of the end surface in the ceramic honeycomb structure body obtained in the first embodiment;

FIG. 13 is a SEM photograph showing a surface of the chamfered part at the edge of the end surface in the conventional ceramic honeycomb structure body; and

FIG. 14 is a perspective diagram showing a conventional ceramic honeycomb structure body.

### DETAILED DESCRIPTION OF THE PREFERRED EMBODIMENTS

Hereinafter, various embodiments of the present invention will be described with reference to the accompanying drawings. In the following description of the various embodiments, like reference characters or numerals designate like or equivalent component parts throughout the several views.

### First Embodiment

A description will now be given of a ceramic honeycomb structure body and a manufacturing method thereof according to a first embodiment of the present invention.

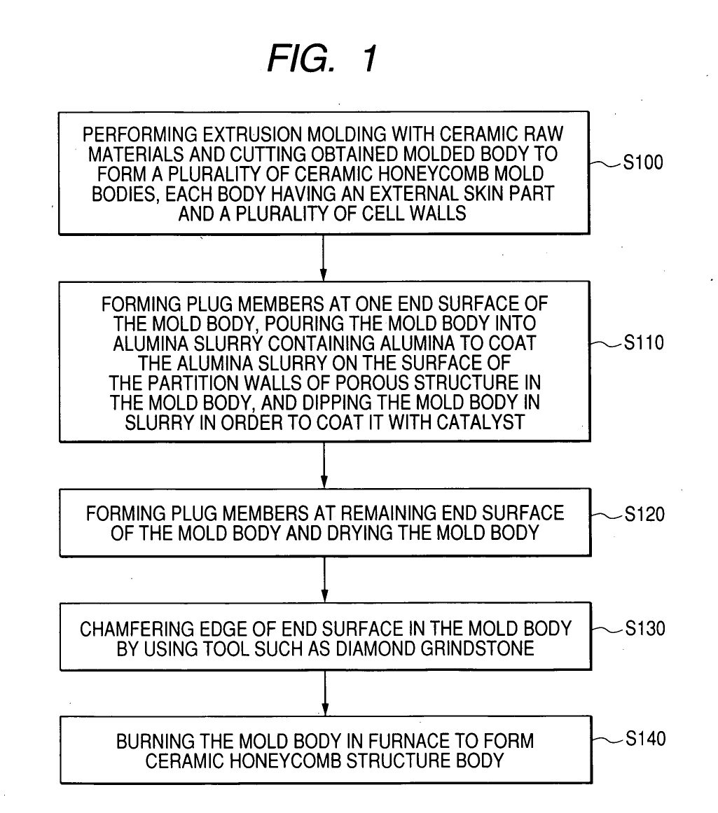

FIG. 1 is a flow chart showing the manufacturing process of the ceramic honeycomb structure body according to the first embodiment of the present invention.

First, an extrusion molding is performed with ceramic raw materials and then cut the obtained mold body so as to form a plurality of ceramic honeycomb structure mold bodies, each having an outer peripheral skin part 11 and a plurality of cell walls 12 (S100).

The plurality of cell walls 12 in each ceramic honeycomb mold body 10 are partition walls of porous structure that form introduction paths and exhaust paths (omitted from diagrams). Through the introduction paths and the exhaust paths, an exhaust gas from an internal combustion engine (omitted from diagrams) is introduces and exhausted to the outside of the body. Plug members are then formed at one end surface of the ceramic honeycomb mold body 10.

Following, alumina slurry containing alumina is poured into the end surface of the mold body 10 so as to coat the alumina slurry on the surface of the partition walls of porous structure (S110). The ceramic honeycomb mold body 10 is then dipped in slurry in order to coat it with a catalyst. The catalyst supported by the alumina layer is coated on the surface of the partition walls in the ceramic honeycomb mold body 10 (S110).

Plug members are then formed at the remaining end surface of the ceramic honeycomb mold body 10, and a drying process for the mold body 10 is performed (S120).

Following, a chamfering process is performed using a diamond grindstone and the like so as to chamfer the edge 101 of the end surface 102 of the ceramic honeycomb mold body 10 (S130).

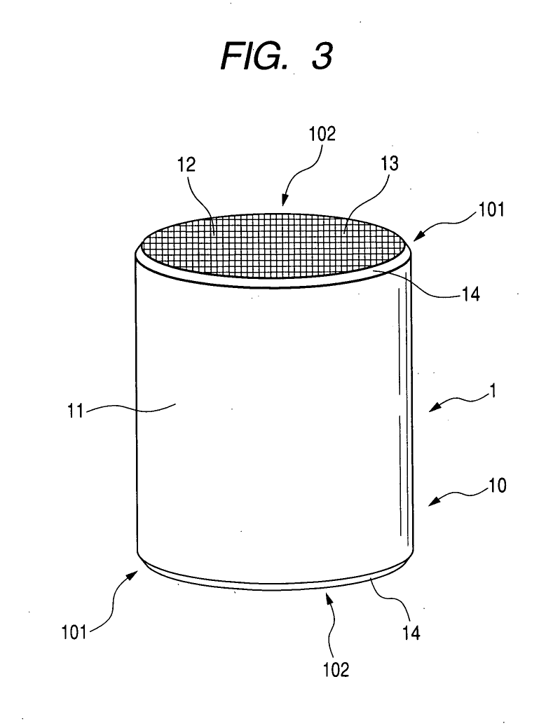

As shown in FIG. 3 described later, the chamfered part at the edge 14 of the end surface in the ceramic honeycomb mold body 10 obtained by S130 is exposed to atmosphere before the burning process.

Finally, a burning process for the ceramic honeycomb mold body 10 is performed in an electric furnace so as to form a ceramic honeycomb structure body 1. In the burning process by the electric furnace, the chamfered part 14 at the edge is directly burned (S140).

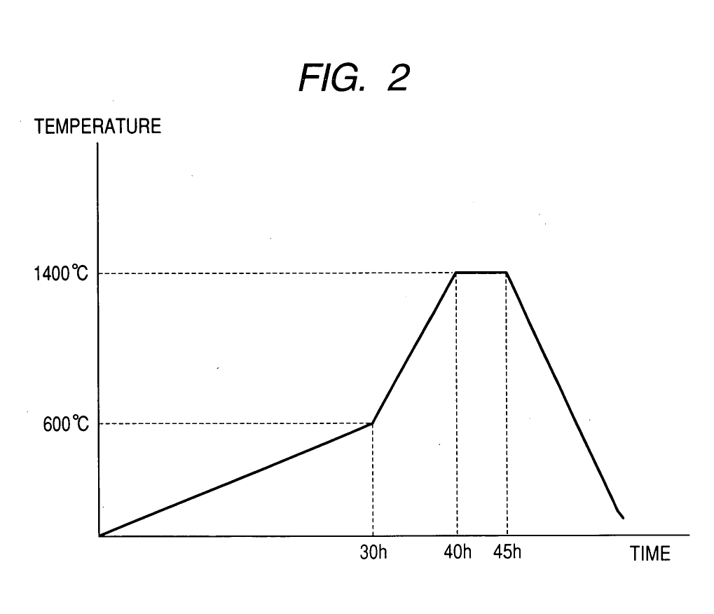

FIG. 2 is a timing diagram showing the temperature control in the burning process in the electric furnace to form the ceramic honeycomb structure body 1 according to the first embodiment.

As shown in FIG. 2, the temperature in the electric furnace during the burning process is gradually increased until 600° C. by the increase rate of 20° C./hour. After approximately thirty hours, the rate of the increase temperature is set to 80° C./hour for ten hours. After ten hours, the temperature of the furnace becomes 1,400° C. The temperature 1,400° C. of the electric furnace is kept for five hours. After five hours, the supply of the electric power to the electric furnace is stopped. The temperature of the electric furnace is gradually decreased in natural cooling for the ceramic honeycomb structure body 1.

FIG. 3 is a perspective diagram of the ceramic honeycomb structure body 1 manufactured by the manufacturing method of the first embodiment. As shown in FIG. 3, the outer peripheral part of the ceramic honeycomb structure body 1 is coated with the outer peripheral skin part 11 of a thickness 0.5 mm.

The inner part of the ceramic honeycomb structure body 1 of the first embodiment comprises of a plurality of the cell walls 12 of 0.1 mm thickness. A plurality of the cell walls 12 are formed in the honeycomb structure body 1 and surrounded by the outer peripheral skin part 11 and a plurality of the cells 13. A width of each cell 13 is 1.0 mm. A plurality of the cells 13 are divided in a lattice pattern by a plurality of the cell walls 12.

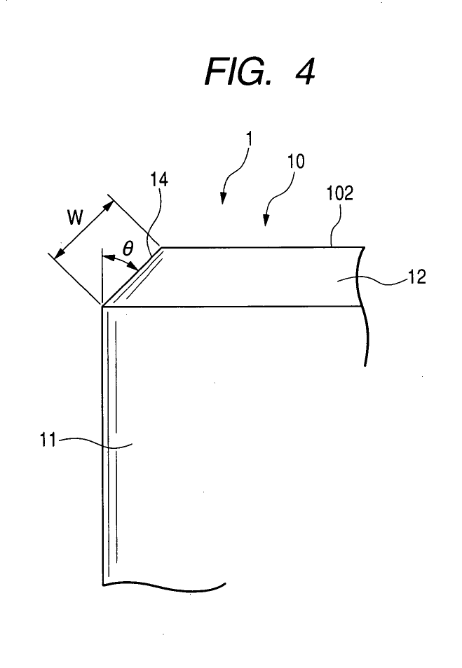

FIG. 4 is a side diagram showing a chamfered part formed at the edge of the end surface 12 in the ceramic honeycomb structure body 1 according to the first embodiment. As shown in FIG. 4, the width W of the C surface of the chamfered part 14 at the edge of the end surface in the body 1 is set to within 0.5 mm to 5.0 mm.

In the first embodiment, the angle of the C surface to the axis of the body 1 is set to within an angle of 20° to 70°.

The important feature of the first embodiment of the present invention, the chamfering process to chamfer the edge of the end surface in the ceramic honeycomb mold body 10 is performed after the drying process and before the burning process.

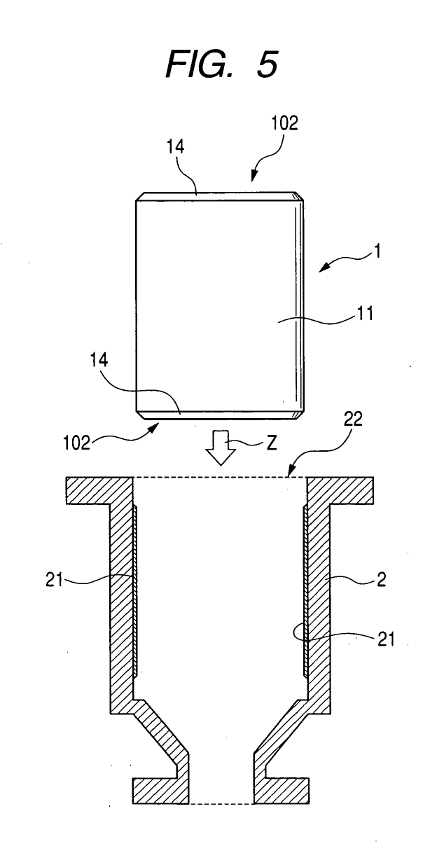

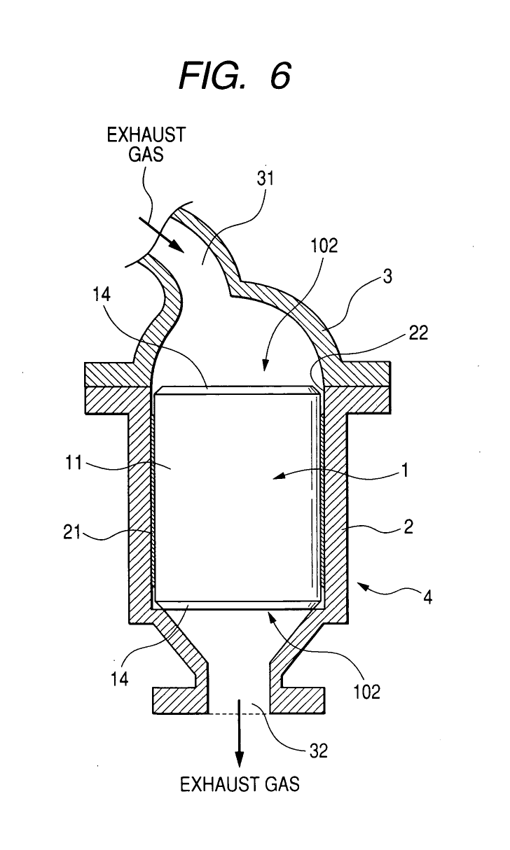

FIG. 5 is a diagram showing a housing process of the ceramic honeycomb structure body 1 into a steel case in the manufacturing process of the first embodiment. FIG. 6 is a sectional diagram of an exhaust gas purifying apparatus equipped with the ceramic honeycomb structure body of the first embodiment.

When an automobile is equipped with the ceramic honeycomb structure body 1, formed by the manufacturing method of the first embodiment, as an exhaust gas purifying apparatus 4 shown in FIG. 6, the ceramic honeycomb structure body 1 is contained into the steel case while inserting it from an opening part 22 of the steel case 2 along its axis Z shown in FIG. 5 by using a press fitting tool. The ceramic honeycomb structure body 1 is forcedly fit through a fitting material 21 formed and placed on the inner wall of the steel case 2 and fixed in the steel case 2.

Next, as shown in FIG. 6, the opening part 22 of the steel case 2 containing the ceramic honeycomb structure body 1 therein is placed at and joined to an exhaust gas manihold 3 by bolts. The exhaust gas purifying apparatus 4 is thereby obtained.

The exhaust gas from an internal combustion engine is introduced into the exhaust gas purifying apparatus 4 through an exhaust gas inlet part 31 and passes through a plurality of the cells 12 formed in the ceramic honeycomb structure body 1 where the exhaust gas is purified and the purified exhaust gas is discharged from the exhaust gas outlet part 32 of the exhaust gas purifying apparatus 1. The exhaust gas from the exhaust gas purifying apparatus 4 is discharged to an atmosphere through an exhaust pipe (not shown).

A description will now be given of the operation and effect of the manufacturing method of the ceramic honeycomb structure body according to the first embodiment of the present invention.

One of the important features of the present invention is to perform the chamfering process to chamfer the edge of the end surface in the ceramic honeycomb mold body 10 before the burning process.

The manufacturing method of the present invention can perform the easy chamfering process for the mold body 10 before the burning process because the mold body 10 before the burning process is soft in hardness, when compared with the conventional manufacturing method in which the chamfering process is performed after the burning process. Thereby, the manufacturing process of the present invention can decrease the time necessary to the chamfering process, and further obtain a long lifetime of a working tool such as a diamond for use in the chamfering process. Those features can decrease the total manufacturing cost of the ceramic honeycomb structure body of the present invention.

Further, the manufacturing process of the present invention has the feature to prevent occurrence of edge failure and generation of cracks because unnecessary force is applied to the ceramic honeycomb mold body 10 with a soft hardness during the chamfering process to be performed before the burning process.

Still further, the manufacturing process of the present invention has the feature to reduce the edge failure at the edge 101 of the end surface 102 in the ceramic honeycomb mold body in the manufacturing time period counted from the cutting process for the honeycomb mold body to the burning process thereof because the chamfering process is performed in an early stage before the burning process when compared with the conventional manufacturing method.

Still furthermore, because the burning process is performed under the state where the chamfered part 14 is formed at the edge of the end surface in the mold body 10, it is possible to avoid the concentration of stress to the edge 101 of the end surface 102 in the mold body 10 during the burning process. It is therefore possible to prevent any occurrence of the edge failure and generation of cracks at the edge 101 of the end surface 102 in the ceramic honeycomb mold body 10.

Moreover, because the manufacturing process of the present invention forms the chamfered part 14 at the edge of the end surface in the mold body 10 and the width W of the C surface of the chamfered part is set to a range of 0.5 to 5.0 mm, this can adequately enhance the effect obtained by the chamfering process to be performed before the burning process.

Still moreover, it is possible to prevent occurrence of crack at the cell walls 12 because the cell walls 12 with a thin thickness is not greatly projected from the outer peripheral skin section 11 toward the axis direction of the ceramic honeycomb structure body 1.

Further, because the manufacturing method of the present invention forms within the range of 20° to 70° the angle of the C surface (see FIG. 4) of the chamfered part 14 at the edge of the end surface 102 in the ceramic honeycomb mold body 10, it is further possible to enhance the effect of the present invention in addition to the effect obtained by the chamfering process to be performed before the burning process.

The chamfering process of the present invention is performed to the ceramic honeycomb mold body 10 after the extrusion molding process and the drying process. Because the chamfering process is performed to the mold body 10 in adequate damp-dry state, it is possible to deform the mold body 10 perfectly and to easily perform the chamfering process to the mold body 10.

Moreover, because the surface of the chamfered part 14 at the edge of the end surface in the mold body 10 is directly burned during the burning process, the burning process forms the chamfered part 14 of a cordierite composed of crystal particles of 2MgO.2Al₂O₃.5SiO₂ with a smooth surface. This smooth surface of the chamfered part can avoid the concentration of stress to the edge 101 of the end surface 102 in the body and to avoid the occurrence of the edge failure and the generation of cracks in the edge 101 of the end surface 102.

As described above in detail, according to the first embodiment, it is possible to provide the ceramic honeycomb structure body and its manufacturing method with a superior processability that can extremely lessen the frequent edge failure and cracks therein.

The ceramic honeycomb structure body of the present invention can be used as a catalyst supporter and various filters in an exhaust gas purifying apparatus for capturing particulate contaminants to be exhausted from a diesel engine of a vehicle, for example.

It is also possible to use a cordierite ceramics mainly containing 2MgO.2Al₂.O₃.5SiO₂ as raw materials of ceramics in order to form the ceramic honeycomb structure body of the present invention.

It is further possible to form the ceramic honeycomb structure body obtained after the burning process according to the present invention so that the thickness of the outer peripheral skin part is within a range of 0.3 mm to 0.7 mm, the thickness of the cell wall is set to a range of 0.05 mm to 0.2 mm, and the pitch of the cell wall is set to a range of 1.0 mm to 1.5 mm.

If the width of the C surface is less than 0.5 mm, it can be considered to become impossible to obtain the effect by the formation of the chamfered part at the edge of the end surface of the body.

Further, if the angle of the C surface to the axis of the body is less than 20° or exceeds 70°, this C surface is considered to be equal to the state where no chamfer part is formed at the edge of the end surface in the body. This case can also be considered to become impossible to obtain the effect by the formation of the chamfered part at the edge of the end surface of the body.

### Second Embodiment

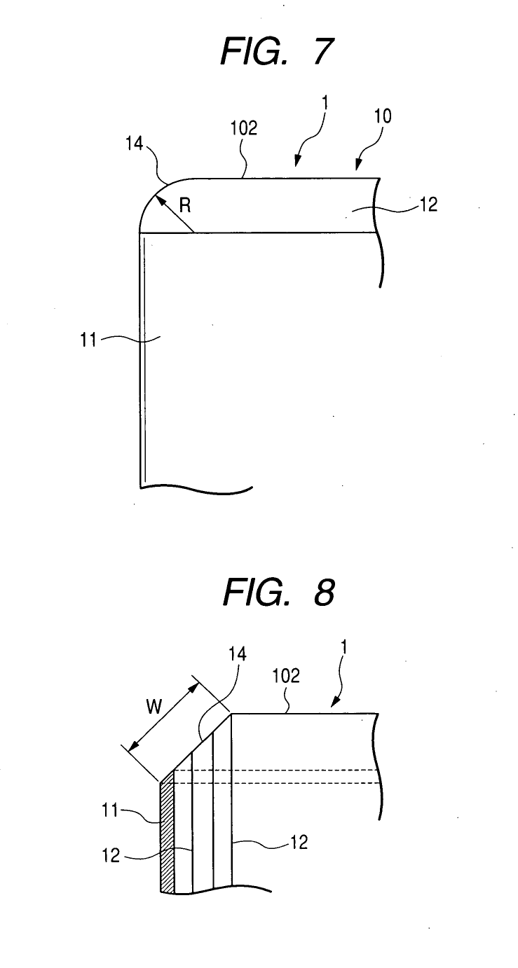

FIG. 7 is a sectional diagram of a chamfered part at the edge of the end surface in the ceramic honeycomb structure body according to a second embodiment of the present invention.

In the second embodiment, the chamfered part at the edge of the end surface in the ceramic honeycomb mold body 10 is formed with a R surface, and the radius of curvature of the R surface is set to a range of 0.5 mm to 3.0 mm.

Other components of the ceramic honeycomb structure body are the same as those of the ceramic honeycomb structure body according to the first embodiment. Therefore the explanation for the same components is omitted here.

In the second embodiment, because the chamfered part 14 at the edge of the end surface of the mold body has a R surface, the stress to be applied to the end surface 102 and the outer peripheral skin part 11 of the ceramic honeycomb mold body 10 can be easily dispersed. This can prevent occurrence of edge failure and cracks in the handling, transmitting, and carrying of the ceramic honeycomb mold body 10 in the following manufacturing processes.

Other remaining effects of the ceramic honeycomb mold body 10 of the second embodiment are the same as those of the first embodiment.

If the radius of curvature of the R surface is less than 0.5 mm, it can be considered to become impossible to obtain the effect by the formation of the chamfered part at the edge of the end surface of the body.

Further, if the radius of curvature of the R surface exceeds 3.0 mm, because the cell walls of a thin thickness is greatly projected from the outer peripheral skin part toward the axis of the ceramic honeycomb structure body, it is easily caused to generate lacks of the cell walls in the body.

### First Experiment

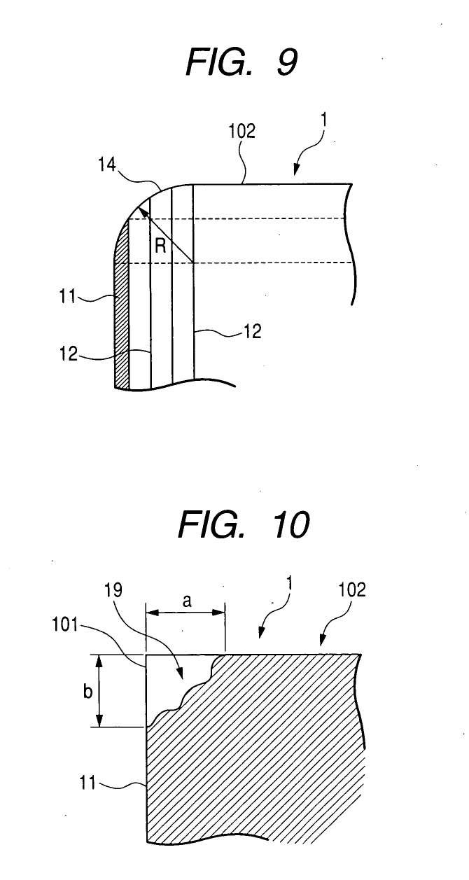

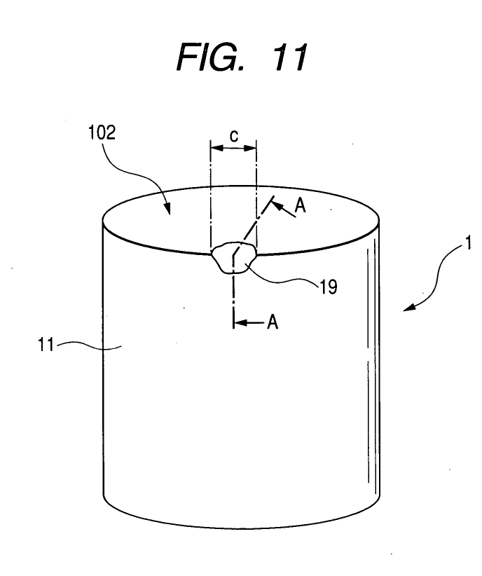

Table 1 shows experimental results regarding edge failure rate and crack generation rate of the ceramic honeycomb structure bodies obtained in the first and second embodiments. FIG. 8 is a sectional diagram of a R surface of the ceramic honeycomb structure body obtained in the first embodiment of the present invention. FIG. 9 is a sectional diagram of a C surface of the ceramic honeycomb structure body obtained in the second embodiment of the present invention. FIG. 10 is a diagram showing an edge failure at the edge of the end surface in a ceramic honeycomb structure body and taken along the line A-A of FIG. 11. FIG. 11 is a perspective diagram showing the edge of the ceramic honeycomb structure body involving an edge failure.

In the first experiment, two types of products, the first type products and the second type products were prepared. Each of the first type products is a cylindrical shaped body of the ceramic honeycomb structure having 400 meshes, a volume of 1,000 cc, a sectional area of 80 cm², an outer peripheral skin part 11 of 0.5 mm, a cell wall 12 of a thickness 4.0 mil (approximately 100 μm), and a cell width of 1.0 mm, and 400 meshes. Each of the second type products is a cylindrical shaped body of the ceramic honeycomb structure having 400 meshes, a volume of 1,100 cc, a sectional area of 80 cm², an outer peripheral skin part 11 of 0.5 mm, a cell wall 12 of a thickness 3.0 mil (approximately 75 μm), a cell width of 1.0 mm, and 400 meshes.

The first experiment has prepared 1,000 units per following each condition of the first type products and the second type products.
(1) No chamfer process is performed;
(2) Width of the chamfered C surface has a range of 0.5 mm, and 1.0 mm to 8.0 mm in increments of 1.0 mm; and
(3) Radius of curvature of the chamfered R surface has a range of 0.5 mm, and 1.0 mm to 5.0 mm in increments of 1.0 mm.

Table 1 shows the experimental result of the rate of edge failure and the rate of crack generation in the first and second products under the various conditions.

The edge failure in the Table 1 means a lacked chip 19 having a depth “a” in diameter direction of 1.6 mm or more, or having a length “b” of 1.6 mm or more in axis direction, where the chip 19 is lacked from the edge 101 of the end surface 102 in the ceramic honeycomb structure body 1, as shown in FIG. 10.

In the first experiment, the edge failure means the condition if the lacked chip 19 shown in FIG. 10 does not satisfy the depth “a” of not more than 3.0 mm in diameter direction, the length “b” of not more than 8.0 mm in axis direction, and the length “c” of not more than 10.0 mm in circumference direction. The crack failure means that an experimenter can check visually the presence of the cracks at the surface of the outer peripheral skin part 11 of the ceramic honeycomb structure body 1.

TABLE 1

| | Edge failure | | Crack generation | |
|---|---|---|---|---|
| | rate (%) | | rate (%) | |
| | Product 1 | Product 2 | Product 1 | Product 2 |
| Without chamfering | 2.1 | 2.3 | 1.2 | 1.5 |
| Width W (mm) | | | | |
| of C surface | | | | |
| 0.5 | 0.7 | 0.8 | 0.9 | 1.1 |
| 1.0 | 0.1 | 0.3 | 0.4 | 0.6 |
| 2.0 | 0.3 | 0.5 | 0.2 | 0.4 |
| 3.0 | 0.6 | 0.6 | 0.4 | 0.3 |
| 4.0 | 0.8 | 1.2 | 0.5 | 0.2 |
| 5.0 | 1.3 | 1.5 | 0.4 | 0.4 |
| 6.0 | 2.1 | 2.7 | 0.6 | 0.5 |
| 7.0 | 2.9 | 3.9 | 0.4 | 0.3 |
| 8.0 | 4.1 | 5.3 | 0.3 | 0.4 |
| Radius R (mm) | | | | |
| of curvature | | | | |
| of R surface | | | | |
| 0.5 | 0.6 | 0.8 | 0.8 | 1.0 |
| 1.0 | 0.2 | 0.3 | 0.4 | 0.5 |
| 2.0 | 0.7 | 0.7 | 0.5 | 0.4 |
| 3.0 | 1.0 | 1.1 | 0.5 | 0.3 |
| 4.0 | 2.3 | 1.9 | 0.3 | 0.4 |
| 5.0 | 3.2 | 2.9 | 0.4 | 0.5 |

The experimental result and Table 1 apparently show that the ceramic honeycomb structure body having the chamfered part 14 of R surface with the width W of a range of 0.5 mm to 5.0 mm has a low rate occurrence of the edge failure and the minimum rate occurrence of the crack generation when compared with the body having no chamfered part at the edge.

On the contrary, if the width W of C surface exceeds 5.0 mm or less than 5.0 mm, the ceramic honeycomb structure body has a high probability of occurrence of the edge failure. It is considered that the reason why is that the cell wall 12 of a thin thickness is greatly projected from the outer peripheral skin portion 11 in the axis direction of the body.

Further, according to Table 1, if the radius R of curvature of R surface of the chamfered part 14 at the edge is set to a range of 0.5 mm to 3.0 mm, the body has a low rate of occurrence of both the edge failure and the crack generation when compared with the ceramic honeycomb structure body having no chamfered edge.

On the contrary, if the radius R of curvature of R surface of the chamfered part 14 at the edge exceeds 3.0 mm, the body has a high rate of occurrence of the edge failure. It is considered that the reason why is that the cell wall 12 of a thin thickness is greatly projected from the outer peripheral skin portion 11 in axis direction, as shown in FIG. 9.

### Second Experiment

The second experiment shows a difference of the surface state between the chamfered part 14 at the edge of the end surface in the ceramic honeycomb structure body 1 of the first embodiment (see FIG. 3, for example) and a chamfered part at the edge of the end surface in a conventional ceramic honeycomb structure body.

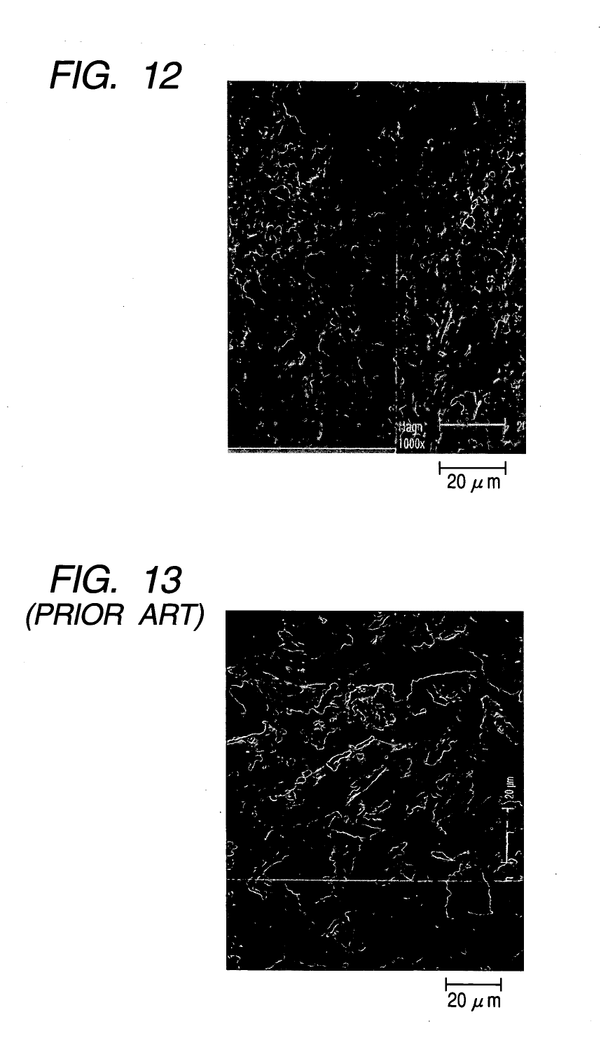

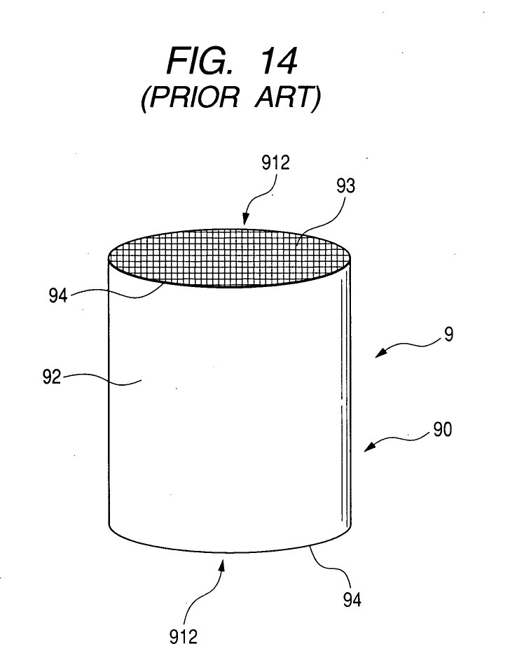

FIG. 12 is a scanning electron microscope (SEM) photograph showing the surface of the chamfered part 14 at the edge of the end surface in the ceramic honeycomb structure body 1 according to the first embodiment. FIG. 13 is a SEM photograph showing the surface of the chamfered part at the edge of the end surface in the conventional ceramic honeycomb structure body. The chamfered part in the conventional ceramic honeycomb structure body is manufactured by the chamfer process after the burning process.

On the contrary, the chamfered part in the ceramic honeycomb structure body of the first embodiment according to the present invention is manufactured by the chamfer process before the burning process. The surface of the chamfered part in the ceramic honeycomb mold body 10 of the present invention is directly burned during the burning process.

In both the SEM photographs shown in FIG. 12 and FIG. 13, the white area indicate the presence of crystal particles of a cordierite 2MgO.2Al₂.O₃.5SiO₂.

FIG. 12 clearly shows that the surface state of the chamfered part 14 at the edge of the end surface in the ceramic honeycomb structure body 1 according to the present invention has a smooth surface of crystal particles. The stress to be applied to the edge 101 of the end surface 102 and the outer peripheral skin part 11 of the ceramic honeycomb structure body 1 can be thereby easily dispersed. This can prevent occurrence of edge failure and cracks.

On the contrary, FIG. 13 clearly shows that the surface of the chamfered part at the edge of the end surface in the conventional ceramic honeycomb structure body has an angular rough surface of crystal particles.

While specific embodiments of the present invention have been described in detail, it will be appreciated by those skilled in the art that various modifications and alternatives to those details could be developed in light of the overall teachings of the disclosure. Accordingly, the particular arrangements disclosed are meant to be illustrative only and not limited to the scope of the present invention which is to be given the full breadth of the following claims and all equivalent thereof.

What is claimed is:

1. A manufacturing method of a ceramic honeycomb structure body, comprising steps of:
performing extrusion molding with ceramic raw materials to form molded one, and then cutting the molded one to form a plurality of honeycomb mold bodies, each honeycomb mold body comprising an outer peripheral skin part and a plurality of cell walls in the honeycomb mold body;
chamfering an edge of an end surface in the honeycomb mold body to form a chamfered part at the edge of the end surface in the honeycomb mold body; and
burning the honeycomb mold body with the chamfered part at the edge of the end surface in order to form a ceramic honeycomb structure body.

2. The manufacturing method according to claim 1, wherein the chamfering process forms a C surface in the edge of the corner part of the honeycomb mold body and the C surface has a width of a range of 0.5 mm to 5.0 mm.

3. The manufacturing method according to claim 2, wherein an angle of the C surface to an axis of the honeycomb mold body is set to a range of 20° to 70°.

4. The manufacturing method according to claim 1, wherein the chamfering process forms a R surface at the edge of the end surface in the honeycomb mold body and the R surface has a radius of curvature, a range of which is 0.5 mm to 5.0 mm.

5. The manufacturing method according to claim 1, wherein the chamfering is performed after a drying process of drying the honeycomb mold body before the burning process of burning the honeycomb mold body.

6. The manufacturing method according to claim 2, wherein the chamfering is performed after a drying process of drying the honeycomb mold body before the burning process of burning the honeycomb mold body.

7. The manufacturing method according to claim 3, wherein the chamfering is performed after a drying process of drying the honeycomb mold body before the burning process of burning the honeycomb mold body.

8. The manufacturing method according to claim 4, wherein the chamfering is performed after a drying process of drying the honeycomb mold body before the burning process of burning the honeycomb mold body.

9. A ceramic honeycomb structure body comprising:
an outer peripheral skin part;
a plurality of cell walls formed in the ceramic honeycomb structure body; and
a chamfered part formed at an edge of an end surface in the ceramic honeycomb structure body, and the chamfered part is obtained by directly burning during manufacturing.

10. The ceramic honeycomb structure body according to claim 9, wherein a C surface having a width of a range of 0.5 mm to 5.0 mm is formed at the chamfered part at the edge of the end surface in the ceramic honeycomb structure body.

11. The ceramic honeycomb structure body according to claim 10, wherein an angle of the C surface to an axis of the ceramic honeycomb structure body is set to a range of 20° to 70°.

12. The ceramic honeycomb structure body according to claim 9, wherein the chamfered part is formed with a R surface of a radius of curvature being a range of 0.5 mm to 5.0 mm.

13. The ceramic honeycomb structure body according to claim 9, wherein the chamfered part has crystal particles of a cordierite 2MgO.2Al₂.O₃.5SiO₂.
